(19) United States
(12) Patent Application Publication
(10) Pub. No.: US 2026/0040211 A1
(43) Pub. Date: Feb. 5, 2026

(54) TRANSITION BETWEEN COMMUNICATION CONFIGURATIONS FOR REDUCED POWER CONSUMPTION

(71) Applicant: QUALCOMM Incorporated, San Diego, CA (US)

(72) Inventors: Diana MAAMARI, San Diego, CA (US); Gabi SARKIS, San Diego, CA (US); Sibasish DAS, San Diego, CA (US)

(21) Appl. No.: 18/792,355

(22) Filed: Aug. 1, 2024

(51) Int. Cl. H04W 52/02

(52) U.S. Cl. CPC H04W 52/0216; H04W 52/0232

(57) ABSTRACT

Methods, systems, and devices for wireless communications are described. A user equipment (UE) may operate in different communications profiles associated with different sets of communication parameters that support different threshold throughputs and threshold processing timelines. Use of a set of communication parameters that supports a lower throughput and/or longer timeline may involve lower power usage but longer latency than a set of communication parameters that supports a higher throughput and/or shorter timeline. The UE may transition between use of a higher power, higher throughput mode and a lower power, lower throughput mode based on configured conditions to match different sets of communication parameters to the expected traffic. For example, a network entity may transmit control signaling to a UE that indicates one or more triggering conditions for transition from use of a first mode to a second mode.

### FIELD OF TECHNOLOGY

The following relates to wireless communications, including transition between communication configurations for reduced power consumption.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving first control signaling that indicates one or more triggering conditions for transitioning by the UE between communication in accordance with a low power, low throughput mode and communication in accordance with a high power, high throughput mode, where: the low power, low throughput mode is associated with a lower throughput, a longer processing timeline, or both; and the high power, high throughput mode is associated with a higher throughput that is greater than the lower throughput, a shorter processing timeline that is less than the longer processing timeline, or both and transitioning, based on satisfaction of a triggering condition of the one or more triggering conditions, from: communication in accordance with the low power, low throughput mode to communication in accordance with the high power, high throughput mode; or communication in accordance with the high power, high throughput mode to communication in accordance with the low power, low throughput mode.

A UE for wireless communications is described. The UE may include one or more memories storing processor executable code, a transceiver, and one or more processors coupled with the one or more memories and the transceiver. The one or more processors may individually or collectively be operable to execute the code to cause the UE to receive, via the transceiver, first control signaling that indicates one or more triggering conditions for transitioning by the UE between communication in accordance with a low power, low throughput mode and communication in accordance with a high power, high throughput mode, where: the low power, low throughput mode is associated with a lower throughput, a longer processing timeline, or both; and the high power, high throughput mode is associated with a higher throughput that is greater than the lower throughput, a shorter processing timeline that is less than the longer processing timeline, or both and transition, based on satisfaction of a triggering condition of the one or more triggering conditions, from: communication in accordance with the low power, low throughput mode to communication in accordance with the high power, high throughput mode; or communication in accordance with the high power, high throughput mode to communication in accordance with the low power, low throughput mode.

Another UE for wireless communications is described. The UE may include means for receiving first control signaling that indicates one or more triggering conditions for transitioning by the UE between communication in accordance with a low power, low throughput mode and communication in accordance with a high power, high throughput mode, where: the low power, low throughput mode is associated with a lower throughput, a longer processing timeline, or both; and the high power, high throughput mode is associated with a higher throughput that is greater than the lower throughput, a shorter processing timeline that is less than the longer processing timeline, or both and means for transitioning, based on satisfaction of a triggering condition of the one or more triggering conditions, from: communication in accordance with the low power, low throughput mode to communication in accordance with the high power, high throughput mode; or communication in accordance with the high power, high throughput mode to communication in accordance with the low power, low throughput mode.

A non-transitory computer-readable medium storing code for wireless communications is described. The code may include instructions executable by one or more processors to receive first control signaling that indicates one or more triggering conditions for transitioning by the UE between communication in accordance with a low power, low throughput mode and communication in accordance with a high power, high throughput mode, where: the low power, low throughput mode is associated with a lower throughput, a longer processing timeline, or both; and the high power, high throughput mode is associated with a higher throughput that is greater than the lower throughput, a shorter processing timeline that is less than the longer processing timeline, or both and transition, based on satisfaction of a triggering condition of the one or more triggering conditions, from: communication in accordance with the low power, low throughput mode to communication in accordance with the high power, high throughput mode; or communication in accordance with the high power, high throughput mode to communication in accordance with the low power, low throughput mode.

Some examples of the method, UEs, and non-transitory computer-readable medium described herein may further include operations, features, means, or instructions for transmitting, to a network entity prior to any transition, second control signaling indicating the transition.

Some examples of the method, UEs, and non-transitory computer-readable medium described herein may further include operations, features, means, or instructions for receiving, from a network entity, scheduling information for a set of multiple communications in accordance with the low power, low throughput mode, the scheduling information further indicating one or more scheduling gaps between the set of multiple communications.

Some examples of the method, UEs, and non-transitory computer-readable medium described herein may further include operations, features, means, or instructions for communicating, with a network entity, control signaling indicating that the UE may be operating in the low power, low throughput mode, where the scheduling information indicates the one or more scheduling gaps based on the control signaling.

In some examples of the method, UEs, and non-transitory computer-readable medium described herein, the control signaling that indicates the one or more triggering conditions indicates one or more of a threshold packet delay budget or a buffer status threshold.

Some examples of the method, UEs, and non-transitory computer-readable medium described herein may further include operations, features, means, or instructions for transitioning from communication in accordance with the low power, low throughput mode to communication in accordance with the high power, high throughput mode based on satisfaction of any combination of the one or more triggering conditions, where the one or more triggering conditions include: a packet delay exceeding the threshold packet delay budget, a buffer status exceeding the buffer status threshold, pending transmission of a negative acknowledgment feedback message for a downlink message, reception of a negative acknowledgment feedback message for an uplink message, scheduling of uplink traffic associated with a priority above a priority threshold, a number of retransmissions of a packet exceeding a threshold quantity of retransmissions, or any combination thereof.

Some examples of the method, UEs, and non-transitory computer-readable medium described herein may further include operations, features, means, or instructions for transitioning from communication in accordance with the high power, high throughput mode to communication in accordance with the low power, low throughput mode based on satisfaction of any combination of the one or more triggering conditions, where the one or more triggering conditions include: a packet delay below the threshold packet delay budget, a buffer status below the buffer status threshold, reception of a downlink message that indicates an end of a downlink burst, or any combination thereof.

Some examples of the method, UEs, and non-transitory computer-readable medium described herein may further include operations, features, means, or instructions for transmitting, prior to any transition, a channel quality indicator (CQI) report that indicates a CQI below a threshold and transitioning from communication in accordance with the low power, low throughput mode to communication in accordance with the high power, high throughput mode based on transmission of the CQI report that indicates the CQI below the threshold.

Some examples of the method, UEs, and non-transitory computer-readable medium described herein may further include operations, features, means, or instructions for receiving, via the first control signaling or second control signaling, an indication of a first bandwidth part (BWP) associated with the low power, low throughput mode and a second BWP associated with the low power, low throughput mode, where the second BWP may have a different bandwidth than the first BWP, where communicating in accordance with the high power, high throughput mode includes communicating via the first BWP, and where communicating in accordance with the high power, high throughput mode includes communicating via the second BWP.

Some examples of the method, UEs, and non-transitory computer-readable medium described herein may further include operations, features, means, or instructions for receiving, via the first control signaling or second control signaling, an indication of a BWP associated with both the low power, low throughput mode and the high power, high throughput mode.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports transition between communication configurations for reduced power consumption in accordance with one or more aspects of the present disclosure.

FIG. 2 shows an example of a communications timeline that supports transition between communication configurations for reduced power consumption in accordance with one or more aspects of the present disclosure.

FIG. 3 shows an example of a communication state transition diagram that supports transition between communication configurations for reduced power consumption in accordance with one or more aspects of the present disclosure.

FIG. 4 shows examples communications timelines that support transition between communication configurations for reduced power consumption in accordance with one or more aspects of the present disclosure.

FIG. 5 shows an example of a wireless communications system that supports transition between communication configurations for reduced power consumption in accordance with one or more aspects of the present disclosure.

FIG. 6 shows an example of a process flow that supports transition between communication configurations for reduced power consumption in accordance with one or more aspects of the present disclosure.

FIGS. 7 and 8 show block diagrams of devices that support transition between communication configurations for reduced power consumption in accordance with one or more aspects of the present disclosure.

FIG. 9 shows a block diagram of a communications manager that supports transition between communication configurations for reduced power consumption in accordance with one or more aspects of the present disclosure.

FIG. 10 shows a diagram of a system including a device that supports transition between communication configurations for reduced power consumption in accordance with one or more aspects of the present disclosure.

FIG. 11 shows a flowchart illustrating methods that support transition between communication configurations for reduced power consumption in accordance with one or more aspects of the present disclosure.

### DETAILED DESCRIPTION

In wireless communications systems, a user equipment (UE) may operate in accordance with different communication profiles or modes. The communication profiles may be associated with different sets of communication parameters and may support different threshold (e.g., maximum) throughputs and threshold (e.g., minimum) processing timelines. A communication profile may represent examples of a configuration profile, a bandwidth part (BWP) configuration, or some other type of configuration and may be referred to as a set of communication parameters. The communication parameters may include bandwidth, rank, modulation and coding scheme (MCS), or any combination thereof. To operate using a higher throughput and/or shorter processing timeline, the UE may increase the voltage supplied to the internal baseband clock and/or may increase the frequency of the internal baseband clock, which may increase the power consumption at the UE (e.g., which may result in a quadratic increase in power consumption). Thus, operation using a set of communication parameters that support a higher throughput and shorter processing timeline may involve or otherwise correspond to operation in a higher power mode. Use of a set of communication parameters that supports a lower throughput and/or longer timeline, however, may involve longer latency. And thus, operation using a set of communication parameters that support a lower throughput and longer processing timeline may involve or otherwise correspond to operation in a lower power mode. Efficient scheduling may involve matching different sets of communication parameters to the expected traffic.

Aspects of the disclosure involve configured conditions for transition by a UE between use of a higher power mode and a lower power mode. A network entity may transmit control signaling to a UE that indicates one or more triggering conditions for transition from use of a first power mode to a second power mode. For example, the first power mode may be a low power, low throughput mode, and the second power mode may be a high power, high throughput mode. In such examples, the triggering conditions may include one or more of: a packet delay that exceeds a threshold; pending transmission of a negative acknowledgment (NACK) feedback message for a downlink message; arrival of high priority uplink data for transmission; reception of a NACK feedback message for an uplink message; a threshold quantity of retransmissions for an uplink message; a drop in channel quality, or reception of downlink control information (DCI) that indicates to transition to the higher power set of communication parameters. As another example, if the transition is from the higher power, higher throughput mode to the lower power, lower throughput mode, the triggering conditions may include one or more of: a delay status below a threshold; a buffer status at or below a threshold; or an end of burst indication for a downlink burst.

Aspects of the disclosure are initially described in the context of wireless communications systems. Aspects of the disclosure are further illustrated by and described with reference to communication timelines, communication state transition diagrams, process flows, apparatus diagrams, system diagrams, and flowcharts that relate to transition between communication configurations for reduced power consumption.

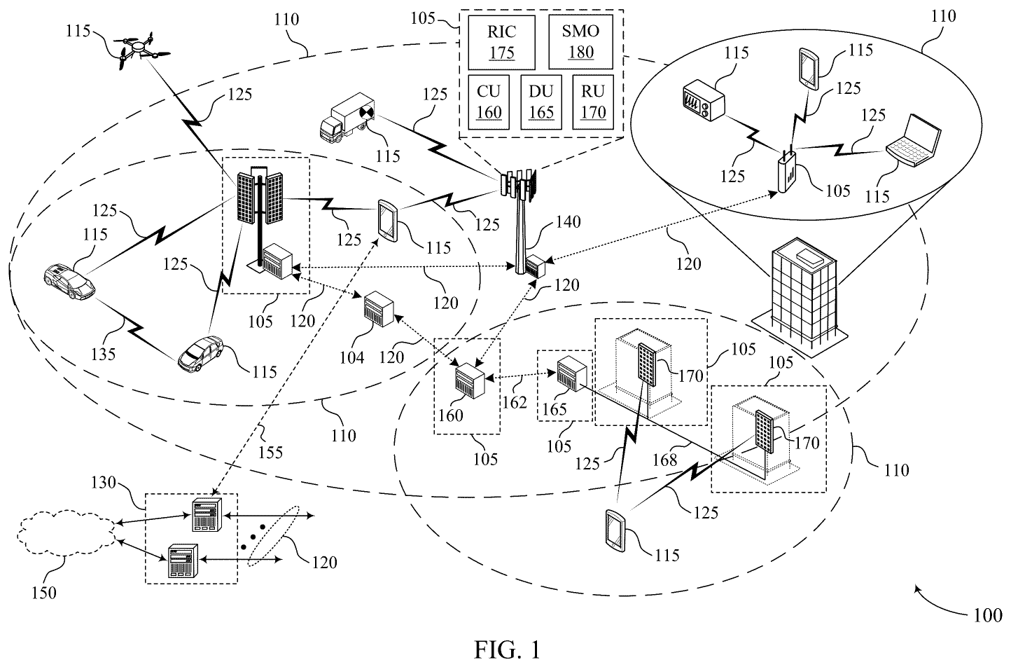

FIG. 1 shows an example of a wireless communications system 100 that supports transition between communication configurations for reduced power consumption in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a BWP) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may operate in different communications profiles associated with different sets of communication parameters and accordingly different power consumption levels. The different communications profiles may support different threshold (e.g., maximum) throughputs and threshold (e.g., minimum) processing timelines. To operate using a higher throughput and/or shorter processing timeline, the UE may increase the voltage supplied to the internal baseband clock and/or may increase the frequency of the internal baseband clock, which may increase the power consumption at the UE (e.g., may involve a quadratic increase in power consumption). Accordingly, operation in accordance with a higher throughput and/or shorter processing timeline may be referred to as operation in accordance with a higher power, higher throughput mode. Similarly, operation in accordance with a lower throughput and/or longer processing timeline may be referred to as operation in accordance with a lower power, lower throughput mode. Use of the lower throughput and/or longer processing timeline (e.g., the lower power, lower throughput mode), however, involves longer latency. Thus, efficient scheduling may involve matching different sets of communication parameters to the expected traffic.

A UE 115 may transition between use of a higher power, higher throughput mode and a lower power, lower throughput mode based on configured conditions. For example, a network entity 105 may transmit control signaling to a UE that indicates one or more triggering conditions for transition from use of a first mode to a second mode. For example, if the transition is from the lower power, lower throughput mode to the higher power, higher throughput mode, the triggering conditions may include one or more of: a packet delay that exceeds a threshold; pending transmission of a NACK feedback message for a downlink message; a buffer status above a threshold; arrival of high priority uplink data for transmission; reception of a NACK feedback message for an uplink message; a threshold quantity of retransmissions for an uplink message; a drop in channel quality (e.g., channel quality indicator (CQI)), or reception of DCI that indicates to transition to the higher power set of communication parameters. As another example, if the transition is from the higher power, higher throughput mode to the lower power, lower throughput mode, the triggering conditions include one or more of: a delay status below threshold; a buffer status at or below a threshold; or an end of burst indication for a downlink burst.

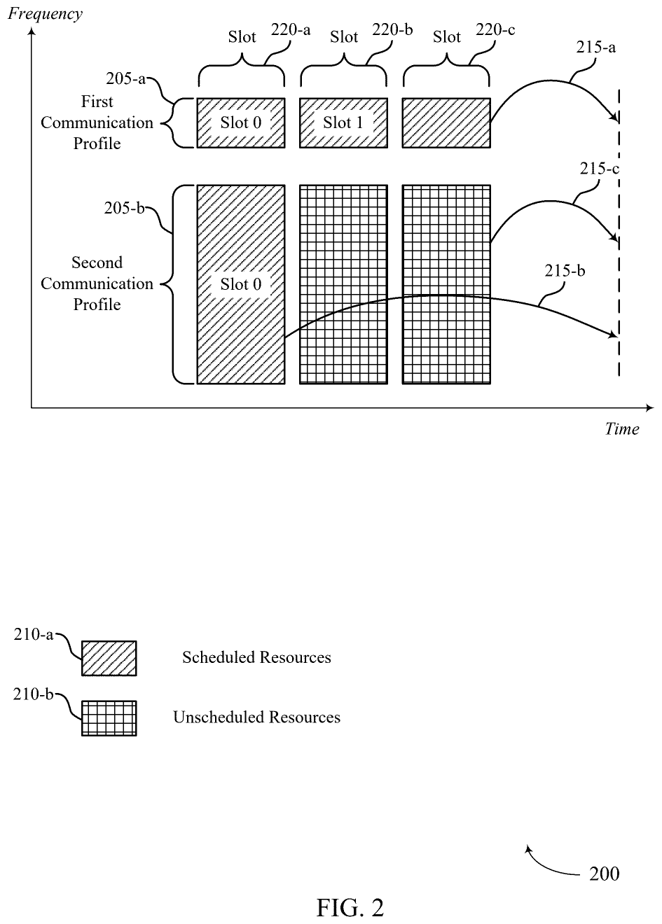

FIG. 2 shows an example of a communications timeline 200 that supports transition between communication configurations for reduced power consumption in accordance with one or more aspects of the present disclosure. The communications timeline 200 may implement or may be implemented by aspects of the wireless communications system 100.

In some cases, the UE 115 may communicate in accordance with a first communication profile 205-a (e.g., a first set of communication parameters, which also may be referred to as a first BWP configuration) associated with a narrow bandwidth (e.g., a narrowband operation mode (NB)). The maximum throughput may be limited by the maximum available bandwidth in the first communication profile 205-a. For example, the sustained throughput may be limited. The first communication profile 205-a may additionally be associated with a processing timeline 215-a (e.g., a minimum processing timeline), which may correspond to a shortest time period between an end of a message received at the UE 115 and a beginning of a scheduled feedback opportunity. The UE 115 may process the received message and generate feedback within the processing timeline 215-a. Accordingly, the amount of data to decode within the processing timeline 215-a (e.g., feedback timeline) may be relatively low as compared with longer processing timelines, which may be supported by the relatively limited bandwidth available for scheduling in the slot 220-c within the first communication profile 205-a, and instantaneous throughput may be limited.

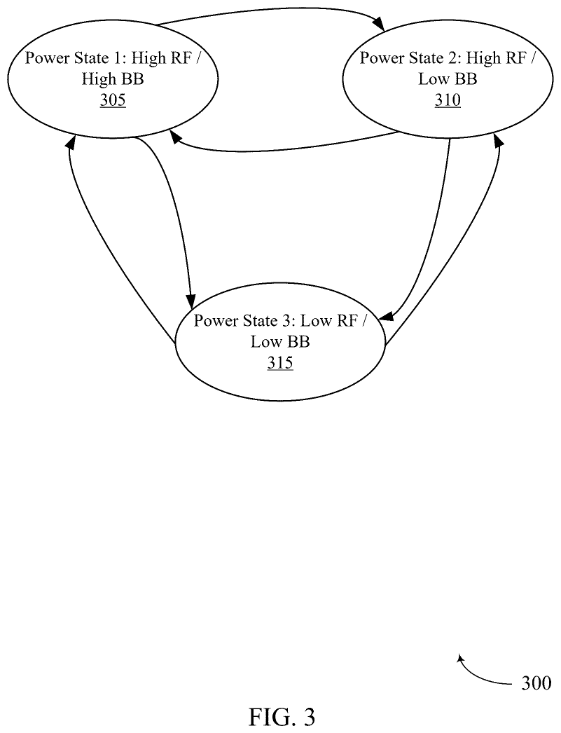

In some cases, the UE 115 may communicate in accordance with a second communication profile 205-b (e.g., a second set of communication parameters, which also may be referred to as a second BWP configuration) associated with a relatively wide bandwidth (e.g., wideband operation mode (WB)). The maximum throughput supported by the second communication profile 205-b may be higher than the maximum throughput associated with the first communication profile 205-a because the second communication profile 205-b may include a wider bandwidth. The network entity 105 may transmit more data within a given time period using the second communication profile 205-b than the first communication profile 205-a based on the wider bandwidth. In the example of FIG. 3, the scheduled resources 210-a may span across each of the slot 220-a, the slot 220-b, and the slot 220-c using the first communication profile 205-a. The network entity 105 may transmit data via the maximum bandwidth of the first communication profile 205-a in each slot 220. The scheduled resources 210-a may span a single slot (e.g., the slot 220-a) using the second communication profile 205-b, and the slots 220-b and 220-c may include unscheduled resources 210-b. The network entity 105 may transmit the same amount of data via the maximum bandwidth of the first communication profile 205-a in a single slot (e.g., the slot 220-a), which illustrates the increased data rate and data throughput supported by the second communication profile.

While communicating according to the second communication profile 205-b,the network entity 105 may schedule communications in any of the slot 220-a, the slot 220-b, or the slot 220-c, and the processing timeline 215-c supported by the second communication profile 205-b (e.g., the supported minimum processing timeline) may be the same as in the processing timeline 215-a supported by the first communication profile 205-a. A shortest possible time period over which the UE 115 may process received data and transmit feedback while communicating according to the second communication profile 205-b may correspond to the processing timeline 215-c and may be the same as the processing timeline 215-a.

If the UE 115 receives data in the slot 220-c, the UE 115 may be scheduled to transmit feedback for the data by the same feedback deadline (e.g., illustrated by the dashed line in FIG. 2). The processing timeline 215-b illustrated in FIG. 2 may illustrate a timeline for the UE 115 to prepare feedback when the UE 115 receives data in the slot 220-a and is not scheduled in the slots 220-b and 220-c, and may be greater than the processing timeline 215-c for the second communication profile 205-b. Additionally, or alternatively, in some cases, the processing timeline 215-c for the second communication profile 205-b may be longer than the processing timeline 215-a for the first communication profile 205-a to provide more time for the UE 115 to process the extra bandwidth. For example, although not illustrated in FIG. 2, the feedback deadline or the second communication profile 205-b may be later in time than the feedback deadline for the first communication profile 205-a, which may thereby increase the processing timeline 215-c. In some examples, if the processing timeline 215-c for the wideband scheduling may be the same as the processing timeline 215-a for narrowband scheduling, which may keep the baseband of the UE 115 at a lower power state than in wideband scheduling with a tighter processing timeline such as the processing timeline 215-b.

In some examples, the network entity 105 may switch from the first communication profile 205-a to the second communication profile 205-b for one or more reasons. For example, the second communication profile 205-b may support communication with more devices, may support an improved connection, or the like. However, the network entity 105 may not have a reason to increase throughput, in some cases. For example, the network entity 105 may have the same amount of data to transmit in a same time period, but the network entity 105 may benefit from the increased bandwidth configuration, among other examples. In such cases, techniques for dynamically adjusting a threshold (e.g., maximum) throughput, a threshold (e.g., minimum) processing timeline 215, or both for a communication profile 205 may be beneficial, as the adjustments may provide for reduced power consumption by the UE 115 while operating according to a communication profile 205 that may otherwise be associated with higher throughput or shorter processing timelines.

The second communication profile 205-b may involve higher clock frequency and thus higher supply voltage to the internal baseband clock of the UE 115 to support the higher clock frequency as compared to the first communication profile 205-a. The increase of the clock frequency and the increase of the supply voltage may lead to a quadratic increase in power consumption at the UE 115 in operation in the second communication profile 205-b as compared to the first communication profile 205-a. The UE 115 may use the second communication profile 205-b to achieve high throughput and wideband scheduling. Thus, the UE 115 may attempt to match use of the second communication profile 205-b to communication loads that demand the second communication profile 205-b. For example, the network entity 105 may inform the UE 115 of a duration for which the UE 115 will be scheduled with wideband communications such that the UE 115 may set the internal clock frequency and supply voltage to the internal to support the wideband communications for the indicated duration. For example, the UE 115 may be informed that the UE 115 may not be scheduled with sustained peak throughput and the UE 115 may not need to ramp up the internal clock frequency at the highest power state. For example, in FIG. 2, the network entity 105 may inform the UE 115 that WB scheduling is only used in the slot 220-a, and accordingly the UE 115 may relax the processing timeline and the baseband of the UE 115 may be kept in the low power state for the slot 220-b and the slot 220-c.

In some examples, the network entity 105 may guarantee to the UE 115 that the maximum scheduled throughput may not exceed a limit, that the feedback timeline is relaxed, and/or that there will be gaps between physical downlink shared channel (PDSCH) transmissions, in which case the UE 115 may enter a lower power state (e.g., may use communication parameters associated with lower power consumption such as the first communication profile 205-a). For example, the network entity 105 may schedule gaps where no further data is transmitted, when the UE 115 is in the low power, low throughput mode to allow the UE 115 to operate in the lower power mode. The gaps may provide the UE 115 more time to process the just received data as the UE 115 may operate accordingly to a longer processing timeline in the low power, low throughput mode. In the high power, high throughput mode, the network entity 105 may not schedule such gaps, and the UE 115 may receive data (e.g., PDSCH transmissions) to process more frequently. When the network entity 105 does not have as much data to transmit to the UE 115, the UE 115 accordingly may transition to the low power, low throughput mode. When there is less data to process, the UE may use less power (e.g., lower voltages supplied to the internal clocks, lower clock frequency).

In some examples, the network entity 105 may implement an efficient scheduling mode. For example, the network entity 105 may indicate to the UE 115 that a maximum schedulable sustained throughout is lower than the peak throughput possible given the communication profile 205. As another example, the network entity 105 may indicate to the UE 115 that a minimum data processing (or feedback) timeline is larger than the minimum possible value reported by the UE 115. For example, the network entity 105 may inform UE 115 that the UE 115 will not be scheduled at the wideband peak throughput and that the feedback deadline is the same as for narrowband for the slot 220-b and the slot 220-c.

FIG. 3 shows an example of a communication state transition diagram 300 that supports transition between communication configurations for reduced power consumption in accordance with one or more aspects of the present disclosure. The communication state transition diagram 300 may implement or may be implemented by aspects of the wireless communications system 100.

In some examples, the UE 115 may operate in accordance with multiple different power states that map to different radio frequency (RF) and baseband assumptions. For example, a first power state 305 may be associated with high RF and high baseband power demands. For example, the first power state 305 may be associated with large bandwidth (e.g., wideband communications or X quantity of component carriers), a tight N1 processing timeline, and a high sustained throughput. In the first power state 305, the UE 115 may ramp up the internal clock rate and may power the internal at a high voltage level to support the large bandwidth, tight processing timeline, and high throughput. The second power state 310 may be associated with high RF and low baseband power demands. For example, the second power state 310 may be associated with large bandwidth (e.g., wideband communications or X quantity of component carriers), a more relaxed N1 processing timeline, and a more limited throughput. The more limited throughput of the second power state 310 may be indicated through a scaling factor that scales the peak throughput (for example, via implicitly setting the internal clock rate or voltage level supplied to the internal clock to a lower level than at the first power state). Accordingly, the second power state 310 may be associated with a lower power consumption than the first power state 305. The third power state 315 may be associated with low RF and low baseband power demands. For example, the second power state 310 may be associated with smaller bandwidth (e.g., narrowband communications or a reduced capability (RedCap) bandwidth), the more relaxed N1 processing timeline, and the more limited throughput. For example, the N1 processing timeline and the throughput of the third power state 315 may be the same as the N1 processing timeline and the throughput of the second power state 310.

As shown in FIG. 3, the UE 115 may transition between the power states (e.g., the first power state 305, the second power state 310, and the third power state 315). In some examples, the network entity 105 may explicitly or implicitly indicate to the UE 115 which power state the UE 115 should operate in, and accordingly the UE 115 may set the internal clock frequency and the supply voltage for the internal clock to match the traffic expected. In some examples, the UE 115 may transmit signaling to the network entity 105 indicating a suggested power state.

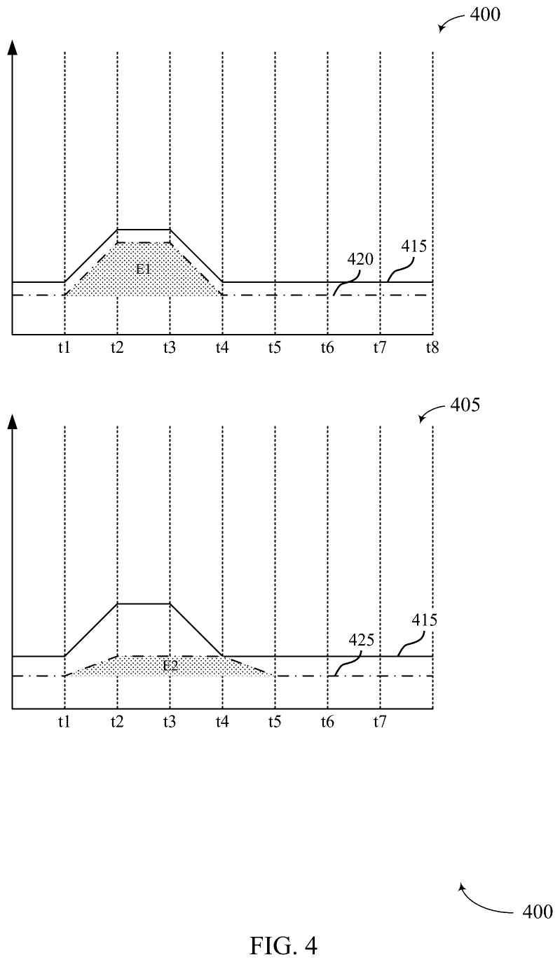

FIG. 4 shows an example of a communications timeline 400 and a communication timeline 405 that supports transition between communication configurations for reduced power consumption in accordance with one or more aspects of the present disclosure. The communications timeline 400 and the communication timeline 405 may implement or may be implemented by aspects of the wireless communications system 100.

The communications timeline 400 shows an example where the UE 115 operates in accordance with the first power state 305 as described with reference to FIG. 3 between the times t1 and t4. For example, the UE 115 may be indicated to switch to wideband communications at time to, and the UE may begin switching to wideband communication at time t1. The UE may also switch to the high baseband parameters (e.g., a tight processing timeline, and high throughput. Based on the tight processing timeline and the high throughput, the UE 115 may complete the scheduled communications at time t4 and may switch back to a lower power state (e.g., the third power state 315 as described with reference to FIG. 3) The line 415 shows the power consumption associated with the RF communications. Accordingly, the line 415 shows the increased power consumption between times t1 and t4 while the UE 115 operates in wideband as compared to when the UE 115 operates in narrowband between times to and t1 and between times t4 and t8. The line 420 shows the power consumption associated with the baseband of the UE 115. Accordingly, the line 420 shows the increased power consumption between times t1 and t4 while the UE 115 operates with the tight processing timeline and high throughput as compared to when the UE 115 operates with a more relaxed processing timeline and lower throughput between times t0 and t1 and between times t4 and t8. Accordingly, E1 corresponds to the energy used by the baseband while in the first power state 305 between times t1 and t4.

The communication timeline 405 shows an example where the UE 115 operates in accordance with the second power state 310 as described with reference to FIG. 3 between the times t1 and t4. For example, the UE 115 may be indicated to switch to wideband communications at time t0, and the UE 115 may begin switching to wideband communication at time t1. The baseband parameters of the second power state 310 may be relaxed compared to the baseband parameters of the first power state 305. Based on more relaxed baseband parameters, the UE 115 may take longer to complete the communications (e.g., until the time t5). The UE 115 may complete the scheduled communications at time t5 and may switch back to a lower power state (e.g., the third power state 315 as described with reference to FIG. 3) The line 425 shows the power consumption associated with the baseband of the UE 115. The line 425 shows the power consumption between times t1 and t5 while the UE 115 is higher than between times t0 and t1 and between times t5 and t8 but lower than the power consumption between times t1 and t4 of the communications timeline 400 where the UE operates in the first power state 305. Accordingly, E2 corresponds to the energy used by the baseband while in the second power state 310 between times t1 and t4. For the same communication, the UE 115 may save energy by operating in accordance with the second power state 310 as compared to the first power state to if E2<E1.

As described herein, however, a lower power state or mode with a higher bandwidth and a low baseband may increase latency as compared to a higher power state or mode with the higher bandwidth and high baseband power demand, yet the lower power state saves energy by using a lower internal clock frequency and lower supply voltage to the internal clock of the UE 115.

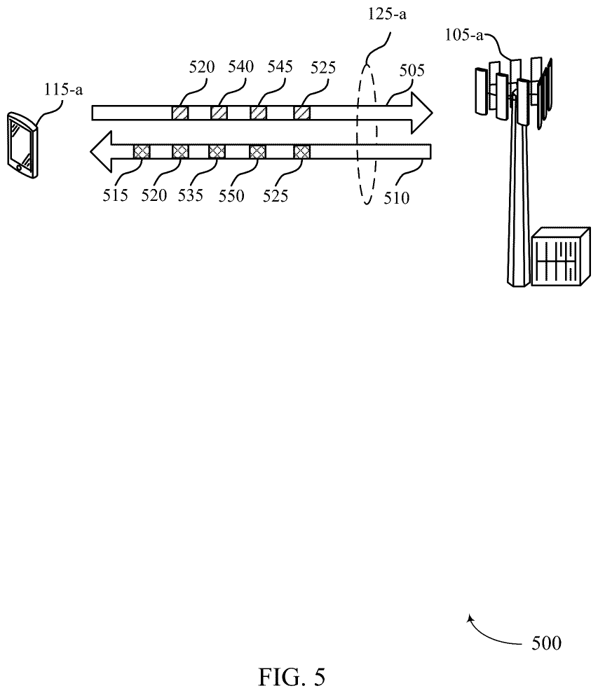

FIG. 5 shows an example of a wireless communications system 500 that supports transition between communication configurations for reduced power consumption in accordance with one or more aspects of the present disclosure. The wireless communications system 500 may implement or may be implemented by aspects of the wireless communications system 100. For example, the wireless communications system 500 includes a UE 115-a and a network entity 105-a, which may be examples of a UE 115 and a network entity 105 described with respect to FIG. 1.

The network entity 105-a may communicate with the UE 115-a via a communication link 125-a, which may be an example of an NR or LTE link between the UE 115-a and the network entity 105-a. In some cases, the communication link 125-a may include an example of an access link (e.g., a Uu link). The communication link 125-a may include a bi-directional link that enables both uplink and downlink communication. For example, the UE 115-a may transmit uplink signals 505, such as uplink control signals or uplink data signals, to the network entity 105-a using the communication link 125-a, and the network entity 105-a may transmit downlink signals 510, such as downlink control signals or downlink data signals, to the UE 115-a using the communication link 125-a.

In some examples, the UE 115-a may operate in accordance with different power states or modes (e.g., in accordance with different sets of communication parameters associated with different energy consumption levels). For example, a first power/throughput mode may be associated with a first throughput and/or processing timeline, and a second power/throughput mode may be associated with a second throughput and/or processing timeline. In some examples, the network entity 105-a may transmit control signaling 515 that may indicate one or more triggering conditions for transitioning the UE 115-a from the first power/throughput mode to the second power/throughput mode. For example, the UE 115-a may perform a first communication 520 with the network entity 105-a at a first time in accordance with the first power/throughput mode. The UE 115-a may perform a second communication 525 with the network entity 105-a at a second time in accordance with the second power/throughput mode. Between the first time and the second time, the UE 115-a may transition from the first power/throughput mode to the second power/throughput mode based on satisfaction of a triggering condition of the one or more triggering conditions indicated in the control signaling 515.

In some examples, the UE 115 may be configured to communicate at the first time in the lower power, lower throughput mode with the high RF and low baseband demands (e.g., the second power state 310 as described with reference to FIG. 3), and the one or more triggering conditions may be configured in the control signaling 515 to trigger a transition from the lower power, lower throughput mode with the high RF and low baseband power demands to the higher power, higher throughput mode with the high RF and high baseband demands (e.g., the first power state 305 as described with reference to FIG. 3). For example, a first set of communication parameters may be associated with the lower power, lower throughput mode and a second set of communication parameters may be associated with the higher power, higher throughput state (e.g., the first set of communication parameters may include a longer processing timeline and/or a lower throughput than the second set of communication parameters). One such example triggering condition may be an uplink experienced delay above a configurable threshold. For example, the lower power, lower throughput mode may add additional delays due to a longer processing timeline or lower throughput than the higher power, higher throughput mode, and thus the UE 115-a may transition to the higher power, higher throughput when delay approaches a configured threshold. For example, the threshold delay may be based on a packet delay budget (PDB). Another example triggering condition may be that the UE 115-a has a pending NACK to transmit to the network entity 105-a for a downlink message. For example, the first communication 520 may be downlink message, and the UE 115-a may not have successfully received the downlink message. Accordingly, the UE 115-a may transition to the higher power, higher throughput mode (e.g., to increase the baseband assumptions) to increase the probability of success of reception of a retransmission of the NACKed downlink message.

Another example triggering condition for a transition from the lower power state to the higher power, higher throughput mode may be that the buffer status of the UE 115-a is above a configurable threshold. Another example triggering condition for a transition from the lower power, lower throughput mode to the higher power, higher throughput mode may be the arrival of uplink traffic to transmit (e.g., from higher layers of the UE 115-a) that satisfies a priority threshold. For example, the UE 115-a may transition to the higher power, higher throughput mode to transmit the high priority uplink data in the second communication 525. For example, the UE 115-a may transition to the higher power, higher throughput mode when uplink traffic for transmission arrives on high priority logical channels of the UE 115-a. Another example triggering condition for a transition from the lower power, lower throughput mode to the higher power, higher throughput mode may be reception of a NACK from the network entity 105-a for an uplink message (e.g., the first communication 520 may be an uplink message). For example, the UE 115-a may transition to the higher power, higher throughput mode to increase the probability that the network entity 105-a will successfully receive the retransmission of the NACKed uplink message. Another example triggering condition for a transition from the lower power, lower throughput mode to the higher power, higher throughput mode may be that a quantity of retransmissions of the first communication 520 exceeds a threshold. For example, the UE 115-a may transition to the higher power, higher throughput mode to increase the probability that the network entity 105-a will successfully receive a subsequent retransmission. Another example triggering condition for a transition from the lower power, lower throughput mode to the higher power, higher throughput mode may be reception of a type of DCI 550 that indicates to transition from the lower power, lower throughput mode to the higher power, higher throughput mode.

In some examples, the UE 115-a may perform measurements on one or more channel state information (CSI) reference signals (CSI-RSs) 535 transmitted by the network entity 105-a to estimate the quality of the communication channel between the network entity 105-a and the UE 115-a. For example, the UE 115-a may generate a CQI based on the one or more CSI-RSs 535. The UE 115-a may transmit a CQI report 540 that indicates the generated CQI. For example, the CQI report 540 may be a CSI report that indicates the generated CQI. Another example triggering condition for a transition from the lower power, lower throughput mode to the higher power, higher throughput mode may be that the CQI drops below a configured threshold (e.g., drops by a threshold reference signal received power (RSRP) threshold or reference signal received quality (RSRQ) threshold) with respect to a previously reported CQI. For example, the CQI threshold may be configured in the control signaling 515. For example, communications with the lower baseband demand may be successful in high channel quality scenarios, but lower channel quality scenarios may demand higher baseband demands (e.g., higher throughput and/or tighter processing timelines) in order to increase the probability of successful communication. Conversely, if the UE 115-a is operating in a higher power, higher throughput mode, the UE 115-a may transition to the lower power, lower throughput mode if the CQI exceeds a configured threshold.

In some examples, the UE 115 may be configured to communicate at the first time in the higher power, higher throughput mode with the high RF and high baseband demands (e.g., the first power state 305 as described with reference to FIG. 3), and the one or more triggering conditions may be configured in the control signaling 515 to trigger a transition from the higher power, higher throughput mode with the high RF and low baseband power demands to the lower power, lower throughput mode with the high RF and low baseband demands (e.g., the second power state 310 as described with reference to FIG. 3). For example, the first set of communication parameters may be associated with the higher power, higher throughput mode and the second set of communication parameters may be associated with the lower power, lower throughput mode (e.g., the first set of communication parameters may include a tighter processing timeline and/or a higher throughput than the second set of communication parameters). One such example triggering condition may be an end of burst indication in a downlink message. For example, the first communication 520 may be a downlink message which may include an end of burst indication. Another example triggering condition may be a delay status (e.g., PDB for uplink) above a configured threshold (e.g., which may indicate that uplink traffic is delay tolerant). Another such example triggering condition for a transition from the higher power, higher throughput mode to the lower power, lower throughput mode may be an uplink experienced delay below a configurable threshold (e.g., with respect to the PDB), which may indicate that the uplink traffic can afford additional delay associated with the lower power, lower throughput mode. Another example triggering condition for a transition from the higher power, higher throughput mode to the lower power, lower throughput mode may be that the buffer status of the UE 115-a is at or below a configurable threshold. In some examples, the configurable threshold may be zero (e.g., when the UE 115-a has no uplink traffic to transmit). In some examples, the UE 115-a may monitor for DCI 550 from the network entity 105-a that indicates to transition from the higher power, higher throughput mode to the lower power, lower throughput mode.

In some examples, when the UE 115-a transitions from use of the first power/throughput mode to the power/throughput mode, the UE 115-a may transmit control signaling 545 to the network entity 105-a indicating the transition. For example, the control signaling 545 may be an uplink MAC control element (MAC-CE) or uplink control information (UCI) conveyed via a physical uplink control channel (PUCCH).

In some examples, the UE 115-a may be configured (e.g., via the control signaling 515) with two BWPs. A first BWP of the two BWPs may be configured for operation with the lower power, lower throughput mode e.g., the relaxed processing timeline and/or low throughput) and a second BWP of the BWPs may be configured for operation with the higher power, higher throughput mode (e.g., the tight processing timeline and/or high throughput). In such examples, the UE 115-a may use the first BWP for communication in accordance with the lower power, lower throughput mode and the second BWP for communication in accordance with the higher power, higher throughput mode. In some examples, the UE 115-a may be configured with a single BWP and two sets of communications parameters (e.g., associated with the higher power, higher throughput mode and the lower power, lower throughput mode). In such examples, the UE 115-a may use the same BWP for communication in accordance with both the higher power, higher throughput mode and the lower power, lower throughput mode.

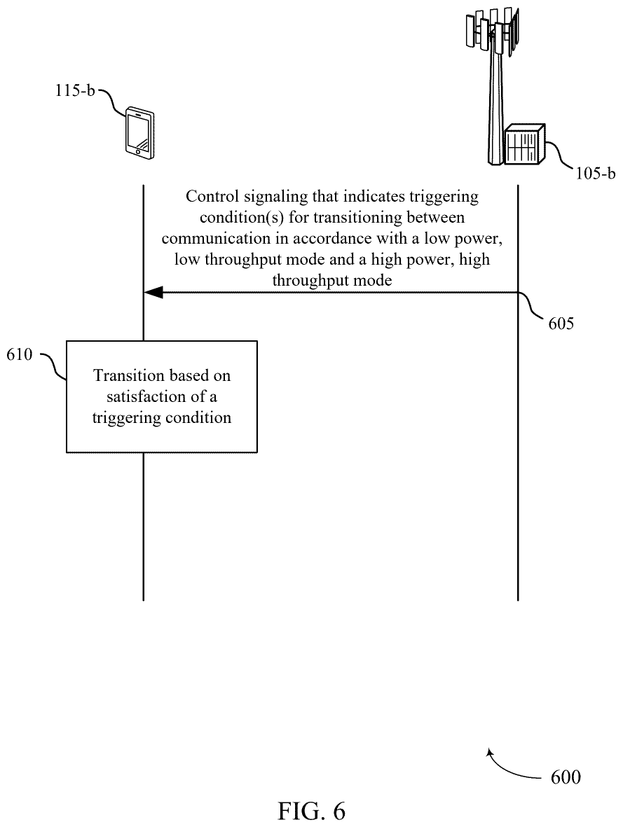

FIG. 6 shows an example of a process flow 600 that supports transition between communication configurations for reduced power consumption in accordance with one or more aspects of the present disclosure. The process flow 600 may include a UE 115-b and a network entity 105-b, which may be examples of a UE 115 and a network entity 105 as described herein. In the following description of the process flow 600, the communications between the network entity 105-b and the UE 115-b may be transmitted in a different order than the example order shown, or the operations performed by the network entity 105-b and the UE 115-b may be performed in different orders or at different times. Some operations may also be omitted from the process flow 600, and other operations may be added to the process flow 600.

At 605, the UE 115-b may receive, from the network entity 105-b, first control signaling that indicates one or more triggering conditions for transitioning by the UE 115-b between communication in accordance with a low power, low throughput mode and communication in accordance with a high power, high throughput mode. The low power, low throughput mode may be associated with a lower throughput, a longer processing timeline, or both. The high power, high throughput mode may be associated with a higher throughput that is greater than the lower throughput, a shorter processing timeline that is less than the longer processing timeline, or both

At 610, the UE 115-b may transition, based on satisfaction of a triggering condition of the one or more triggering conditions, from: communication in accordance with the low power, low throughput mode to communication in accordance with the high power, high throughput mode; or communication in accordance with the high power, high throughput mode to communication in accordance with the low power, low throughput mode.

In some examples, the UE 115-b may transmit, to the network entity 105-b prior to any transition (prior to a transition from a low power, low throughput mode to a high power, high throughput mode; prior to a transition from a high power, high throughput mode to a low power, low throughput mode), second control signaling indicating the transition. Thus, for example, the UE 115-b may transmit the second control signaling indicating a transition from the high power, high throughput mode from the low power, low throughput mode prior to the transition from the high power, high throughput mode from the low power, low throughput mode, or the UE 115-b may transmit the second control signaling indicating a transition from the low power, low throughput mode to the high power, high throughput mode prior to the transition from the low power, low throughput mode to the high power, high throughput mode.

In some examples, the UE 115-b may receive, from the network entity 105-b, scheduling information for a set of multiple communications in accordance with the low power, low throughput mode, the scheduling information further indicating one or more scheduling gaps between the set of multiple communications. In some examples, the UE 115-b may communicate, with the network entity 105-b, control signaling indicating that the UE 115-b is operating in the low power, low throughput mode, and the scheduling information indicates the one or more scheduling gaps based on the control signaling.

In some examples, the first control signaling that indicates the one or more triggering conditions indicates one or more of a threshold packet delay budget or a buffer status threshold. In some examples, at 610, the UE 115-b may transition from communication in accordance with the low power, low throughput mode to communication in accordance with the high power, high throughput mode based on satisfaction of any combination of the one or more triggering conditions, where the one or more triggering conditions may include: a packet delay exceeding the threshold packet delay budget, a buffer status exceeding the buffer status threshold, pending transmission of a NACK feedback message for a downlink message, reception of a NACK feedback message for an uplink message, scheduling of uplink traffic associated with a priority above a priority threshold, a number of retransmissions of a packet exceeding a threshold quantity of retransmissions, or any combination thereof. In some examples, at 610, the UE 115-b may transition from communication in accordance with the high power, high throughput mode to communication in accordance with the low power, low throughput mode based on satisfaction of any combination of the one or more triggering conditions, where the one or more triggering conditions include: a packet delay below the packet delay threshold, a buffer status below the buffer status threshold, reception of a downlink message that indicates an end of a downlink burst, or any combination thereof.

In some examples, the UE 115-b may transmit, to the network entity 105-b, a CQI report that indicates a CQI below a threshold. In such examples, at 610 the UE 115-b may transition from communication in accordance with the low power, low throughput mode to communication in accordance with the high power, high throughput mode based on the transmission of the channel quality report that indicates the CQI below the threshold.

In some examples, the UE 115-b may receive, via the first control signaling or second control signaling, an indication of a first BWP associated with the low power, low throughput mode and a second BWP associated with the low power, low throughput mode, where the second BWP has a different bandwidth than the first BWP, where communicating in accordance with the high power, high throughput mode includes communicating via the first BWP, and where communicating in accordance with the high power, high throughput mode includes communicating via the second BWP.

In some examples, UE 115-b may receive, via the first control signaling or second control signaling, an indication of a BWP associated with both the low power, low throughput mode and the high power, high throughput mode.

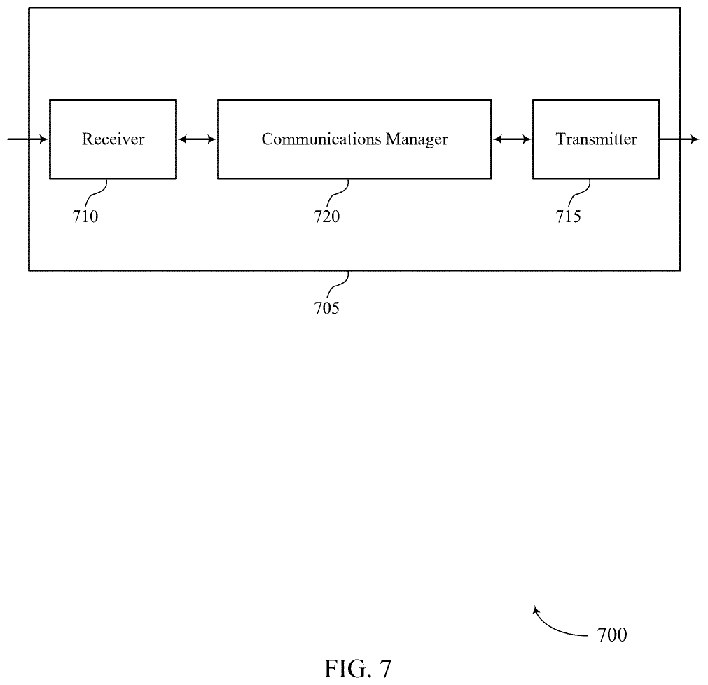

FIG. 7 shows a block diagram 700 of a device 705 that supports transition between communication configurations for reduced power consumption in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to transition between communication configurations for reduced power consumption). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to transition between communication configurations for reduced power consumption). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of transition between communication configurations for reduced power consumption as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving first control signaling that indicates one or more triggering conditions for transitioning by the UE between communication in accordance with a low power, low throughput mode and communication in accordance with a high power, high throughput mode, where: the low power, low throughput mode is associated with a lower throughput, a longer processing timeline, or both; and the high power, high throughput mode is associated with a higher throughput that is greater than the lower throughput, a shorter processing timeline that is less than the longer processing timeline, or both. The communications manager 720 is capable of, configured to, or operable to support a means for transitioning, based on satisfaction of a triggering condition of the one or more triggering conditions, from: communication in accordance with the low power, low throughput mode to communication in accordance with the high power, high throughput mode; or communication in accordance with the high power, high throughput mode to communication in accordance with the low power, low throughput mode.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, reduced power consumption, and more efficient utilization of communication resources.

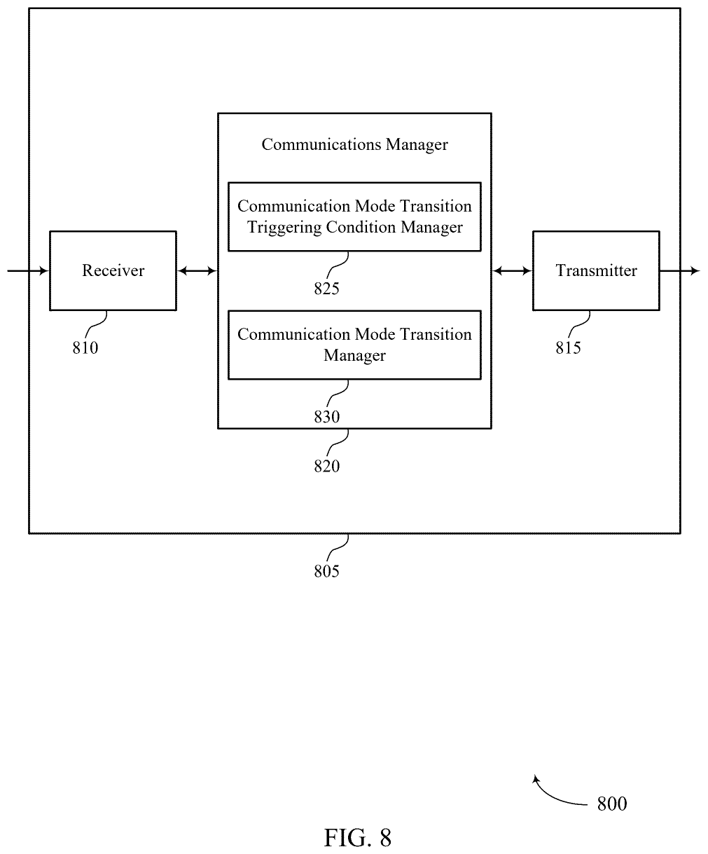

FIG. 8 shows a block diagram 800 of a device 805 that supports transition between communication configurations for reduced power consumption in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to transition between communication configurations for reduced power consumption). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to transition between communication configurations for reduced power consumption). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of transition between communication configurations for reduced power consumption as described herein. For example, the communications manager 820 may include a communication mode transition triggering condition manager 825, a communication mode transition manager 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The communication mode transition triggering condition manager 825 is capable of, configured to, or operable to support a means for receiving first control signaling that indicates one or more triggering conditions for transitioning by the UE between communication in accordance with a low power, low throughput mode and communication in accordance with a high power, high throughput mode, where: the low power, low throughput mode is associated with a lower throughput, a longer processing timeline, or both; and the high power, high throughput mode is associated with a higher throughput that is greater than the lower throughput, a shorter processing timeline that is less than the longer processing timeline, or both. The communication mode transition manager 830 is capable of, configured to, or operable to support a means for transitioning, based on satisfaction of a triggering condition of the one or more triggering conditions, from: communication in accordance with the low power, low throughput mode to communication in accordance with the high power, high throughput mode; or communication in accordance with the high power, high throughput mode to communication in accordance with the low power, low throughput mode.

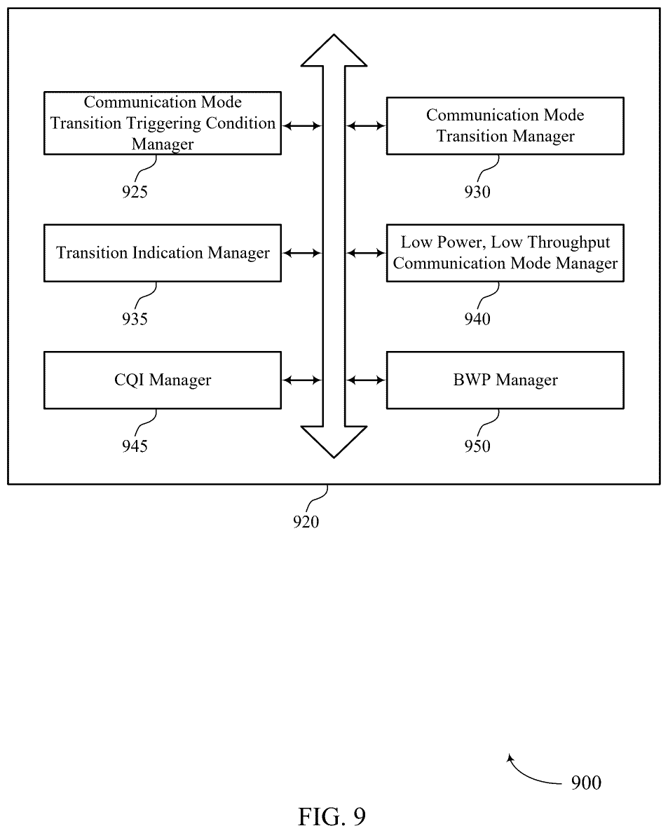

FIG. 9 shows a block diagram 900 of a communications manager 920 that supports transition between communication configurations for reduced power consumption in accordance with one or more aspects of the present disclosure. The communications manager 920 may be an example of aspects of a communications manager 720, a communications manager 820, or both, as described herein. The communications manager 920, or various components thereof, may be an example of means for performing various aspects of transition between communication configurations for reduced power consumption as described herein. For example, the communications manager 920 may include a communication mode transition triggering condition manager 925, a communication mode transition manager 930, a transition indication manager 935, a low power, low throughput communication mode manager 940, a CQI manager 945, a BWP manager 950, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The communication mode transition triggering condition manager 925 is capable of, configured to, or operable to support a means for receiving first control signaling that indicates one or more triggering conditions for transitioning by the UE between communication in accordance with a low power, low throughput mode and communication in accordance with a high power, high throughput mode, where: the low power, low throughput mode is associated with a lower throughput, a longer processing timeline, or both; and the high power, high throughput mode is associated with a higher throughput that is greater than the lower throughput, a shorter processing timeline that is less than the longer processing timeline, or both. The communication mode transition manager 930 is capable of, configured to, or operable to support a means for transitioning, based on satisfaction of a triggering condition of the one or more triggering conditions, from: communication in accordance with the low power, low throughput mode to communication in accordance with the high power, high throughput mode; or communication in accordance with the high power, high throughput mode to communication in accordance with the low power, low throughput mode.

In some examples, the transition indication manager 935 is capable of, configured to, or operable to support a means for transmitting, to a network entity prior to any transition, second control signaling indicating the transition.

In some examples, the low power, low throughput communication mode manager 940 is capable of, configured to, or operable to support a means for receiving, from a network entity, scheduling information for a set of multiple communications in accordance with the low power, low throughput mode, the scheduling information further indicating one or more scheduling gaps between the set of multiple communications.

In some examples, the low power, low throughput communication mode manager 940 is capable of, configured to, or operable to support a means for communicating, with the network entity, control signaling indicating that the UE is operating in the low power, low throughput mode, where the scheduling information indicates the one or more scheduling gaps based on the control signaling.

In some examples, the control signaling that indicates the one or more triggering conditions indicates one or more of a threshold packet delay budget or a buffer status threshold.

In some examples, the communication mode transition manager 930 is capable of, configured to, or operable to support a means for transitioning from communication in accordance with the low power, low throughput mode to communication in accordance with the high power, high throughput mode based on satisfaction of any combination of the one or more triggering conditions, where the one or more triggering conditions include: a packet delay exceeding the threshold packet delay budget, a buffer status exceeding the buffer status threshold, pending transmission of a NACK feedback message for a downlink message, reception of a NACK feedback message for an uplink message, scheduling of uplink traffic associated with a priority above a priority threshold, a number of retransmissions of a packet exceeding a threshold quantity of retransmissions, or any combination thereof.

In some examples, the communication mode transition manager 930 is capable of, configured to, or operable to support a means for transitioning from communication in accordance with the high power, high throughput mode to communication in accordance with the low power, low throughput mode based on satisfaction of any combination of the one or more triggering conditions, where the one or more triggering conditions include: a packet delay below the packet delay threshold, a buffer status below the buffer status threshold, reception of a downlink message that indicates an end of a downlink burst, or any combination thereof.

In some examples, the CQI manager 945 is capable of, configured to, or operable to support a means for transmitting, prior to any transition, a CQI report that indicates a CQI below a threshold. In some examples, the communication mode transition manager 930 is capable of, configured to, or operable to support a means for transitioning from communication in accordance with the low power, low throughput mode to communication in accordance with the high power, high throughput mode based on the transmission of the channel quality report that indicates the CQI below the threshold.

In some examples, the BWP manager 950 is capable of, configured to, or operable to support a means for receiving, via the first control signaling or second control signaling, an indication of a first BWP associated with the low power, low throughput mode and a second BWP associated with the low power, low throughput mode, where the second BWP has a different bandwidth than the first BWP, where communicating in accordance with the high power, high throughput mode includes communicating via the first BWP, and where communicating in accordance with the high power, high throughput mode includes communicating via the second BWP.

In some examples, the BWP manager 950 is capable of, configured to, or operable to support a means for receiving, via the first control signaling or second control signaling, an indication of a BWP associated with both the low power, low throughput mode and the high power, high throughput mode.

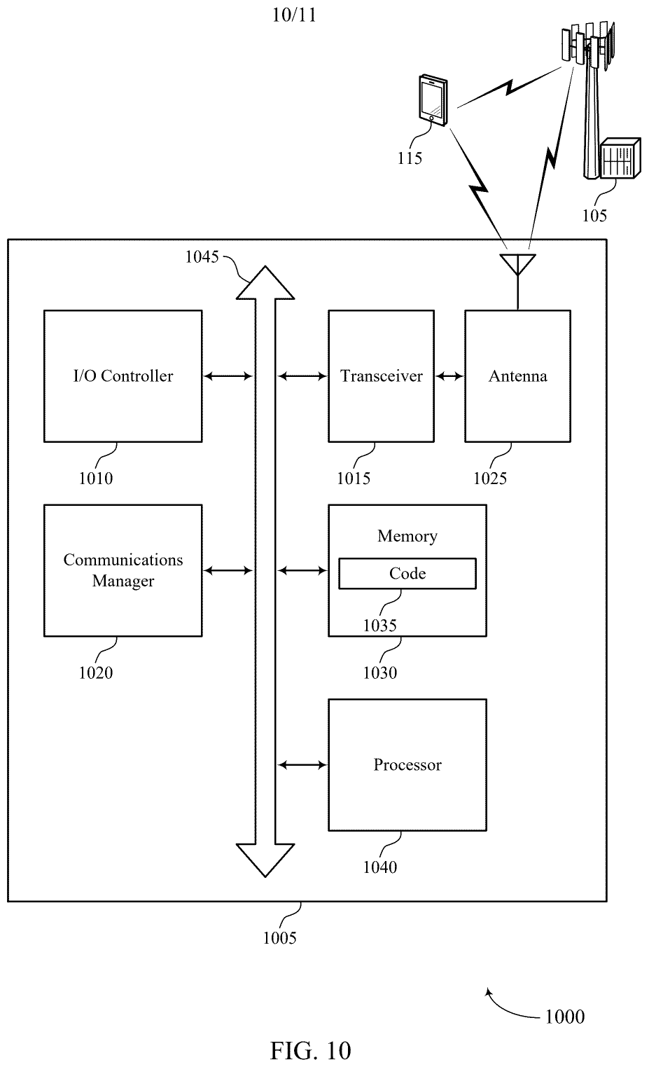

FIG. 10 shows a diagram of a system 1000 including a device 1005 that supports transition between communication configurations for reduced power consumption in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting transition between communication configurations for reduced power consumption). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving first control signaling that indicates one or more triggering conditions for transitioning by the UE between communication in accordance with a low power, low throughput mode and communication in accordance with a high power, high throughput mode, where: the low power, low throughput mode is associated with a lower throughput, a longer processing timeline, or both; and the high power, high throughput mode is associated with a higher throughput that is greater than the lower throughput, a shorter processing timeline that is less than the longer processing timeline, or both. The communications manager 1020 is capable of, configured to, or operable to support a means for transitioning, based on satisfaction of a triggering condition of the one or more triggering conditions, from: communication in accordance with the low power, low throughput mode to communication in accordance with the high power, high throughput mode; or communication in accordance with the high power, high throughput mode to communication in accordance with the low power, low throughput mode.

By including or configuring the communications manager 1020 in accordance with examples as described herein, the device 1005 may support techniques for improved communication reliability, reduced latency, reduced power consumption, more efficient utilization of communication resources, improved coordination between devices, longer battery life, and improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. For example, the communications manager 1020 may be configured to receive or transmit messages or other signaling as described herein via the transceiver 1015. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of transition between communication configurations for reduced power consumption as described herein, or the at least one processor 1040 and the at least one memory 1030 may be otherwise configured to, individually or collectively, perform or support such operations.

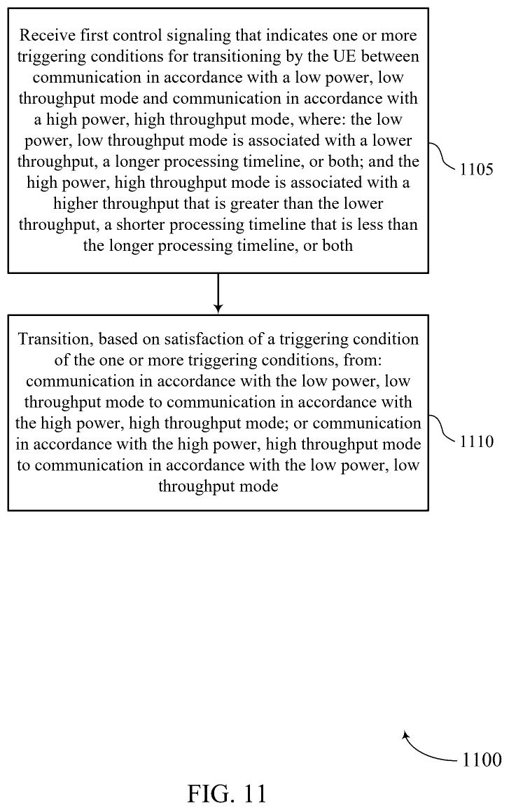

FIG. 11 shows a flowchart illustrating a method 1100 that supports transition between communication configurations for reduced power consumption in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include receiving first control signaling that indicates one or more triggering conditions for transitioning by the UE between communication in accordance with a low power, low throughput mode and communication in accordance with a high power, high throughput mode, where: the low power, low throughput mode is associated with a lower throughput, a longer processing timeline, or both; and the high power, high throughput mode is associated with a higher throughput that is greater than the lower throughput, a shorter processing timeline that is less than the longer processing timeline, or both. The operations of 1105 may be performed in accordance with examples as disclosed herein. In some examples, aspects of the operations of 1105 may be performed by a communication mode transition triggering condition manager 925 as described with reference to FIG. 9. Additionally, or alternatively, means for performing 1105 may, but not necessarily, include, for example, antenna 1025, transceiver 1015, communications manager 1020, memory 1030 (including code 1035), processor 1040 and/or bus 1045.

At 1110, the method may include transitioning, based on satisfaction of a triggering condition of the one or more triggering conditions, from: communication in accordance with the low power, low throughput mode to communication in accordance with the high power, high throughput mode; or communication in accordance with the high power, high throughput mode to communication in accordance with the low power, low throughput mode. The operations of 1110 may be performed in accordance with examples as disclosed herein. In some examples, aspects of the operations of 1110 may be performed by a communication mode transition manager 930 as described with reference to FIG. 9. Additionally, or alternatively, means for performing 1110 may, but not necessarily, include, for example, antenna 1025, transceiver 1015, communications manager 1020, memory 1030 (including code 1035), processor 1040 and/or bus 1045.

The following provides an overview of aspects of the present disclosure:
Aspect 1: A method for wireless communications at a UE, comprising: receiving first control signaling that indicates one or more triggering conditions for transitioning by the UE between communication in accordance with a low power, low throughput mode and communication in accordance with a high power, high throughput mode, wherein: the low power, low throughput mode is associated with a lower throughput, a longer processing timeline, or both; and the high power, high throughput mode is associated with a higher throughput that is greater than the lower throughput, a shorter processing timeline that is less than the longer processing timeline, or both; and transitioning, based at least in part on satisfaction of a triggering condition of the one or more triggering conditions, from: communication in accordance with the low power, low throughput mode to communication in accordance with the high power, high throughput mode; or communication in accordance with the high power, high throughput mode to communication in accordance with the low power, low throughput mode
Aspect 2: The method of aspect 1, further comprising: transmitting, to a network entity prior to any transition, second control signaling indicating the transition.
Aspect 3: The method of any of aspects 1 through 2, further comprising: receiving, from a network entity, scheduling information for a plurality of communications in accordance with the low power, low throughput mode, the scheduling information further indicating one or more scheduling gaps between the plurality of communications
Aspect 4: The method of aspect 3, further comprising: communicating, with a network entity, control signaling indicating that the UE is operating in the low power, low throughput mode, wherein the scheduling information indicates the one or more scheduling gaps based at least in part on the control signaling.
Aspect 5: The method of any of aspects 1 through 4, wherein the control signaling that indicates the one or more triggering conditions indicates one or more of a threshold packet delay budget or a buffer status threshold.
Aspect 6: The method of aspect 5, further comprising: transitioning from communication in accordance with the low power, low throughput mode to communication in accordance with the high power, high throughput mode based at least in part on satisfaction of any combination of the one or more triggering conditions, wherein the one or more triggering conditions comprise: a packet delay exceeding the threshold packet delay budget, a buffer status exceeding the buffer status threshold, pending transmission of a NACK feedback message for a downlink message, reception of a NACK feedback message for an uplink message, scheduling of uplink traffic associated with a priority above a priority threshold, a number of retransmissions of a packet exceeding a threshold quantity of retransmissions, or any combination thereof.
Aspect 7: The method of aspect 5, further comprising: transitioning from communication in accordance with the high power, high throughput mode to communication in accordance with the low power, low throughput mode based at least in part on satisfaction of any combination of the one or more triggering conditions, wherein the one or more triggering conditions comprise: a packet delay below the threshold packet delay budget, a buffer status below the buffer status threshold, reception of a downlink message that indicates an end of a downlink burst, or any combination thereof.
Aspect 8: The method of any of aspects 1 through 7, further comprising: transmitting, prior to any transition, a CQI report that indicates a CQI below a threshold; and transitioning from communication in accordance with the low power, low throughput mode to communication in accordance with the high power, high throughput mode based at least in part on transmission of the CQI report that indicates the CQI below the threshold.
Aspect 9: The method of any of aspects 1 through 8, further comprising: receiving, via the first control signaling or second control signaling, an indication of a first BWP associated with the low power, low throughput mode and a second BWP associated with the low power, low throughput mode, wherein the second BWP has a different bandwidth than the first BWP, wherein communicating in accordance with the high power, high throughput mode comprises communicating via the first BWP, and wherein communicating in accordance with the high power, high throughput mode comprises communicating via the second BWP.
Aspect 10: The method of any of aspects 1 through 8, further comprising: receiving, via the first control signaling or second control signaling, an indication of a BWP associated with both the low power, low throughput mode and the high power, high throughput mode.
Aspect 11: A UE for wireless communications, comprising one or more memories storing processor-executable code, a transceiver, and one or more processors coupled with the one or more memories and the transceiver, the one or more processors individually or collectively operable to execute the code to cause the UE to perform a method of any of aspects 1 through 10.
Aspect 12: A UE for wireless communications, comprising at least one means for performing a method of any of aspects 1 through 10.
Aspect 13: A non-transitory computer-readable medium storing code for wireless communications, the code comprising instructions executable by one or more processors to perform a method of any of aspects 1 through 10.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code;
a transceiver; and
one or more processors coupled with the one or more memories and the transceiver, the one or more processors individually or collectively operable to execute the code to cause the UE to:
receive, via the transceiver, first control signaling that indicates one or more triggering conditions for transitioning by the UE between communication in accordance with a low power, low throughput mode and communication in accordance with a high power, high throughput mode, wherein:
the low power, low throughput mode is associated with a lower throughput, a longer processing timeline, or both; and
the high power, high throughput mode is associated with a higher throughput that is greater than the lower throughput, a shorter processing timeline that is less than the longer processing timeline, or both; and
based at least in part on satisfaction of a triggering condition of the one or more triggering conditions,
transition from communication in accordance with the low power, low throughput mode to communication in accordance with the high power, high throughput mode, or
transition from communication in accordance with the high power, high throughput mode to communication in accordance with the low power, low throughput mode.

2. The UE of claim 1, wherein the one or more processors are individually or collectively further operable to execute the code to cause the UE to:
transmit, via the transceiver to a network entity prior to any transition, control signaling indicating the transition.

3. The UE of claim 1, wherein the one or more processors are individually or collectively further operable to execute the code to cause the UE to:
receive, via the transceiver from a network entity, scheduling information for a plurality of communications in accordance with the low power, low throughput mode, the scheduling information further indicating one or more scheduling gaps between the plurality of communications.

4. The UE of claim 3, wherein the one or more processors are individually or collectively further operable to execute the code to cause the UE to:
communicate, with the network entity, control signaling indicating that the UE is operating in the low power, low throughput mode, wherein the scheduling information indicates the one or more scheduling gaps based at least in part on the control signaling.

5. The UE of claim 1, wherein the first control signaling that indicates the one or more triggering conditions indicates one or more of a threshold packet delay budget or a buffer status threshold.

6. The UE of claim 5, wherein:
the one or more triggering conditions comprise:
a packet delay exceeding the threshold packet delay budget,
a buffer status exceeding the buffer status threshold,
pending transmission of a negative acknowledgment feedback message for a downlink message,
reception of a negative acknowledgment feedback message for an uplink message,
scheduling of uplink traffic associated with a priority above a priority threshold,
a number of retransmissions of a packet exceeding a threshold quantity of retransmissions, or
any combination thereof; and
the one or more processors are individually or collectively further operable to execute the code to cause the UE to transition from communication in accordance with the low power, low throughput mode to communication in accordance with the high power, high throughput mode based at least in part on satisfaction of any combination of the one or more triggering conditions.

7. The UE of claim 5, wherein:
the one or more triggering conditions comprise:
a packet delay below the threshold packet delay budget,
a buffer status below the buffer status threshold,
reception of a downlink message that indicates an end of a downlink burst, or
any combination thereof; and
the one or more processors are individually or collectively further operable to execute the code to cause the UE to transition from communication in accordance with the high power, high throughput mode to communication in accordance with the low power, low throughput mode based at least in part on satisfaction of any combination of the one or more triggering conditions.

8. The UE of claim 1, wherein the one or more processors are individually or collectively further operable to execute the code to cause the UE to:
transmit, via the transceiver prior to any transition, a channel quality indicator report that indicates a channel quality indicator below a threshold; and
transition from communication in accordance with the low power, low throughput mode to communication in accordance with the high power, high throughput mode based at least in part on transmission of the channel quality indicator report that indicates the channel quality indicator below the threshold.

9. The UE of claim 1, wherein the one or more processors are individually or collectively further operable to execute the code to cause the UE to:
receive, via the transceiver and via the first control signaling or second control signaling, an indication of a first bandwidth part associated with the low power, low throughput mode and a second bandwidth part associated with the low power, low throughput mode, wherein the second bandwidth part has a different bandwidth than the first bandwidth part, wherein communicating in accordance with the high power, high throughput mode comprises communicating via the first bandwidth part, and wherein communicating in accordance with the high power, high throughput mode comprises communicating via the second bandwidth part.

10. The UE of claim 1, wherein the one or more processors are individually or collectively further operable to execute the code to cause the UE to:
receive, via the transceiver and via the first control signaling or second control signaling, an indication of a bandwidth part associated with both the low power, low throughput mode and the high power, high throughput mode.

11. A method for wireless communications at a user equipment (UE), comprising:
receiving first control signaling that indicates one or more triggering conditions for transitioning by the UE between communication in accordance with a low power, low throughput mode and communication in accordance with a high power, high throughput mode, wherein:
the low power, low throughput mode is associated with a lower throughput, a longer processing timeline, or both; and
the high power, high throughput mode is associated with a higher throughput that is greater than the lower throughput, a shorter processing timeline that is less than the longer processing timeline, or both; and
based at least in part on satisfaction of a triggering condition of the one or more triggering conditions,
transitioning from communication in accordance with the low power, low throughput mode to communication in accordance with the high power, high throughput mode, or
transition from communication in accordance with the high power, high throughput mode to communication in accordance with the low power, low throughput mode.

12. The method of claim 11, further comprising:
transmitting, to a network entity prior to any transition, second control signaling indicating the transition.

13. The method of claim 11, further comprising:
receiving, from a network entity, scheduling information for a plurality of communications in accordance with the low power, low throughput mode, the scheduling information further indicating one or more scheduling gaps between the plurality of communications.

14. The method of claim 13, further comprising:
communicating, with the network entity, control signaling indicating that the UE is operating in the low power, low throughput mode, wherein the scheduling information indicates the one or more scheduling gaps based at least in part on the control signaling.

15. The method of claim 11, wherein the first control signaling that indicates the one or more triggering conditions indicates one or more of a threshold packet delay budget or a buffer status threshold.

16. The method of claim 15, wherein:
the one or more triggering conditions comprise:
a packet delay exceeding the threshold packet delay budget,
a buffer status exceeding the buffer status threshold,
pending transmission of a negative acknowledgment feedback message for a downlink message,
reception of a negative acknowledgment feedback message for an uplink message,
scheduling of uplink traffic associated with a priority above a priority threshold,
a number of retransmissions of a packet exceeding a threshold quantity of retransmissions, or
any combination thereof; and
the method further comprises transitioning from communication in accordance with the low power, low throughput mode to communication in accordance with the high power, high throughput mode based at least in part on satisfaction of any combination of the one or more triggering conditions.

17. The method of claim 15, wherein:
the one or more triggering conditions comprises:
a packet delay below the threshold packet delay budget,
a buffer status below the buffer status threshold,
reception of a downlink message that indicates an end of a downlink burst, or
any combination thereof; and
the method further comprises transitioning from communication in accordance with the high power, high throughput mode to communication in accordance with the low power, low throughput mode based at least in part on satisfaction of any combination of the one or more triggering conditions.

18. The method of claim 11, further comprising:
transmitting, prior to any transition, a channel quality indicator report that indicates a channel quality indicator below a threshold; and
transitioning from communication in accordance with the low power, low throughput mode to communication in accordance with the high power, high throughput mode based at least in part on transmission of the channel quality indicator report that indicates the channel quality indicator below the threshold.

19. The method of claim 11, further comprising:
receiving, via the first control signaling or second control signaling, an indication of a first bandwidth part associated with the low power, low throughput mode and a second bandwidth part associated with the low power, low throughput mode, wherein the second bandwidth part has a different bandwidth than the first bandwidth part, wherein communicating in accordance with the high power, high throughput mode comprises communicating via the first bandwidth part, and wherein communicating in accordance with the high power, high throughput mode comprises communicating via the second bandwidth part.

20. A non-transitory computer-readable medium storing code for wireless communications at a user equipment (UE), the code comprising instructions executable by one or more processors to:
receive first control signaling that indicates one or more triggering conditions for transitioning by the UE between communication in accordance with a low power, low throughput mode and communication in accordance with a high power, high throughput mode, wherein:
the low power, low throughput mode is associated with a lower throughput, a longer processing timeline, or both; and
the high power, high throughput mode is associated with a higher throughput that is greater than the lower throughput, a shorter processing timeline that is less than the longer processing timeline, or both; and
based at least in part on satisfaction of a triggering condition of the one or more triggering conditions,
transition from communication in accordance with the low power, low throughput mode to communication in accordance with the high power, high throughput mode, or
transition from communication in accordance with the high power, high throughput mode to communication in accordance with the low power, low throughput mode.
